(19) United States
(12) Patent Application Publication
(10) Pub. No.: US 2026/0104481 A1
(43) Pub. Date: Apr. 16, 2026

(54) TRAINING SAMPLE EVALUATION IN POSITIONING

(71) Applicant: Nokia Technologies Oy, Espoo (FI)

(72) Inventors: Sajad REZAIE, Aalborg (DK); Oana-Elena BARBU, Aalborg (DK); Athul PRASAD, Naperville, IL (US)

(21) Appl. No.: 19/115,768

(22) PCT Filed: Sep. 29, 2023
(86) PCT No.: PCT/EP2023/077040

§ 371 Date: Mar. 26, 2025

Related U.S. Application Data
(60) Provisional application No. 63/377,647, filed on Sep. 29, 2022.

(51) Int. Cl. G01S 5/02; G06N 20/00

(52) U.S. Cl. CPC G01S 5/0278; G06N 20/00

(57) ABSTRACT

Example embodiments of the present disclosure relate to positioning enhancements. A first device receives, from a second device, first information indicating a target accuracy for positioning and a set of parameters for a label quality evaluation of a training sample. The training sample comprises a radio measurement and label information associated with the radio measurement. The first device determines a quality parameter of the training sample based on the set of parameters, the label information. The first device then transmits a report at least comprising the quality parameter to the second device. In this way, a model for positioning can be well trained with the evaluated training sample, and thus the positioning accuracy is improved.

### FIELD

Various example embodiments of the present disclosure generally relate to the field of telecommunication and in particular, to methods, devices, apparatuses and computer readable storage medium for training sample evaluation in positioning.

### BACKGROUND

In the telecommunication industry, Artificial Intelligence/Machine Learning (AI/ML) models have been employed in telecommunication systems to improve the performance of telecommunications systems. For example, the AI/ML models have been employed for positioning of devices in a communication network. A large dataset of training samples will be used to train the AI/ML models to improve the positioning accuracy. Therefore, it is worthy studying on training sample evaluation for machine learning training in positioning.

### SUMMARY

In a first aspect of the present disclosure, there is provided a first device. The first device comprises at least one processor; and at least one memory storing instructions that, when executed by the at least one processor, cause the first device at least to perform: receiving, from a second device, first information indicating a target accuracy for positioning and a set of parameters for a label quality evaluation of a training sample, the training sample comprising a radio measurement and label information associated with the radio measurement; determining a quality parameter of the training sample based on the set of parameters, the label information, and the target accuracy; and transmitting, to the second device, a report at least comprising the quality parameter.

In a second aspect of the present disclosure, there is provided a second device. The second device comprises at least one processor; and at least one memory storing instructions that, when executed by the at least one processor, cause the second device at least to perform: transmitting, to a first device, first information indicating a target accuracy for positioning and a set of parameters for a label quality evaluation of a training sample, the training sample comprising a radio measurement and label information associated with the radio measurement; and receiving, from the first device, a report at least comprising a quality parameter that is determined based on the set of parameters, the label information, and the target accuracy.

In a third aspect of the present disclosure, there is provided a method. The method comprises: at a first device, receiving, from a second device, first information indicating a target accuracy for positioning and a set of parameters for a label quality evaluation of a training sample, the training sample comprising a radio measurement and label information associated with the radio measurement; determining a quality parameter of the training sample based on the set of parameters, the label information, and the target accuracy; and transmitting, to the second device, a report at least comprising the quality parameter.

In a fourth aspect of the present disclosure, there is provided a method. The method comprises: at a second device, transmitting, to a first device, first information indicating a target accuracy for positioning and a set of parameters for a label quality evaluation of a training sample, the training sample comprising a radio measurement and label information associated with the radio measurement; and receiving, from the first device, a report at least comprising a quality parameter that is determined based on the set of parameters, the label information, and the target accuracy.

In a fifth aspect of the present disclosure, there is provided a first apparatus. The first apparatus comprises means for receiving, from a second apparatus, first information indicating a target accuracy for positioning and a set of parameters for a label quality evaluation of a training sample, the training sample comprising a radio measurement and label information associated with the radio measurement; means for determining a quality parameter of the training sample based on the set of parameters, the label information, and the target accuracy; and means for transmitting, to the second apparatus, a report at least comprising the quality parameter.

In a sixth aspect of the present disclosure, there is provided a second apparatus. The second apparatus comprises means for transmitting, to a first apparatus, first information indicating a target accuracy for positioning and a set of parameters for a label quality evaluation of a training sample, the training sample comprising a radio measurement and label information associated with the radio measurement; and means for receiving, from the first apparatus, a report at least comprising a quality parameter that is determined based on the set of parameters, the label information, and the target accuracy.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling chart for communication according to some example embodiments of the present disclosure;

FIGS. 3A-3C illustrate example position distributions for noisy sources of samples according to some example embodiments of the present disclosure;

FIG. 4 illustrates a flowchart of a method implemented at a first device according to some example embodiments of the present disclosure;

FIG. 5 illustrates a flowchart of a method implemented at a second device according to some example embodiments of the present disclosure;

FIG. 6 illustrates a simplified block diagram of a device that is suitable for implementing example embodiments of the present disclosure; and

FIG. 7 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, “at least one of the following: <a list of two or more elements> and “at least one of <a list of two or more elements> and similar wording, where the list of two or more elements are joined by “and” or “or”, means at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a Next Generation NodeB (NR NB), a Remote Radio Unit (RRU), a radio header (RH), a remote radio head (RRH), Integrated Access and Backhaul (IAB) node, a relay, a low power node such as a femto, a pico, and so forth, depending on the applied terminology and technology. The network device is allowed to be defined as part of a gNB such as for example in CU/DU split in which case the network device is defined to be either a gNB-CU or a gNB-DU.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

### Example Environment

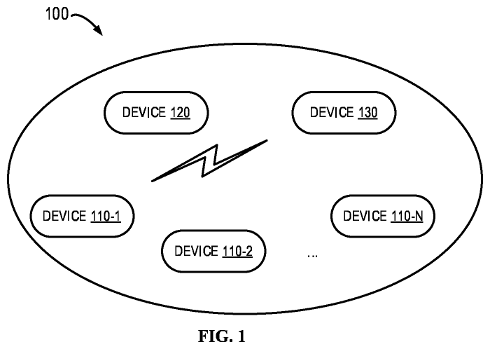

FIG. 1 illustrates an example communication environment 100 in which example embodiments of the present disclosure can be implemented. The communication environment 100 includes a device 110-1, a device 110-2, a device 110-3, . . . , and a device 110-N, which can be collectively referred to as “device(s) 110.” The communication environment also includes a device 120 and a device 130. The device(s) 110, the device 120 and the device 130 can communicate with each other.

In the example of FIG. 1, the device 110 may include a terminal device and the device 130 may include a network device serving the terminal device. The device 120 may include a core network device. For example, the device 120 may include a device on which a location management function (LMF) can be implemented.

In some example embodiments, a central ML unit (also referred to as “central unit”) may be located within the communication environment 100. For example, the central ML unit may be as part of the LMF implemented on the device 120. The central ML unit trains the AI/ML model for positioning by using training samples. The central ML unit may be any suitable unit for data analyzing, including but not limited to a 5G network data analytics function (NWDAF).

In some example embodiments, the central ML unit may collect training samples from a set of data collection devices deployed in certain locations. The data collection device may include a positioning reference unit (PRU) or any other suitable data collection devices. The PRUs are reference units such as devices or network nodes at known locations (that is, having label information). PRUs may take measurements to generate correction data used for refining the location of other target device in the area.

In some example embodiments, the device 110, the device 120 and/or device 130 may perform as the data collection device. For example, the device 110, the device 120 and/or device 130 may provide positioning measurements or estimations in addition to its/their own position(s) via radio access network (RAN) or non-RAN. The positioning information provided by the device 110, the device 120 and/or device 130 is collected in the communication environment 100, thus may be used to analyze the propagation properties of the communication environment 100.

The central ML unit may combine the positioning measurements from different PRUs to train a localization ML framework. The trained ML framework may be deployed at network entities running ML processes and/or algorithms. Such entities may be referred to as host types. Host types carrying out ML processes can be a target device to be positioned, the PRUs and potentially the radio access network (e.g., the network device and or the LMF) to enhance the positioning accuracy.

It is to be understood that the number of devices and their connections shown in FIG. 1 are only for the purpose of illustration without suggesting any limitation. The communication environment 100 may include any suitable number of devices configured to implementing example embodiments of the present disclosure. Although not shown, it would be appreciated that one or more additional devices may be located in the cell of the device 130, and one or more additional cells may be deployed in the communication environment 100. It is noted that although illustrated as a network device, the device 130 may be other device than a network device. Although illustrated as a terminal device, the device 110 may be other device than a terminal device.

In the following, for the purpose of illustration, some example embodiments are described with the device 110 operating as a terminal device and the device 130 operating as a network device. However, in some example embodiments, operations described in connection with a terminal device may be implemented at a network device or other device, and operations described in connection with a network device may be implemented at a terminal device or other device.

In some example embodiments, if the device 110 is a terminal device and the device 130 is a network device, a link from the device 130 to the device 110 is referred to as a downlink (DL), while a link from the device 110 to the device 130 is referred to as an uplink (UL). In DL, the device 130 is a transmitting (TX) device (or a transmitter) and the device 110 is a receiving (RX) device (or a receiver). In UL, the device 110 is a TX device (or a transmitter) and the device 130 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

As mentioned above, the AI/ML can be employed in communication systems to improve the positioning accuracy. The AI/ML model may be trained with a dataset of training samples. To better training the AI/ML model, a large dataset with accurate ground truth or label is needed. However, in many applications, it is difficult to obtain accurate labels (also referred to as golden labels) of the training samples. For example, noisy label refers to an inaccurate value for a target parameter instead of the true or actual value at the measurement time. Therefore, it is worthy studying on training models by using training samples with noisy labels.

In one approach, it has proposed several approaches to train the AI/ML model with noisy labels. For example, it has proposed to update the loss function with a neighbor consistency regularization. In another approach, it has proposed to average over multiple noisy labels to reduce the effects of noisy labels in training of the model.

With the massive deployment of communication infrastructures, the devices in the communication environments may provide positioning measurements and their own positions (which may be used as labels of the positioning measurements). A promising approach for training model in positioning is to use the measurements and positions (labels) provided by the devices in the communication systems as training samples. However, as the obtained positions as labels are inaccurate, these positions may be noisy labels. That is, these training samples contains noisy labels. The evaluation of training samples with noisy labels needs to be improved to enhance the model training in positioning.

### Work Principle and Example Signaling for Communication

As discussed above, it is challenging to evaluate the training sample for training the AI/ML model in positioning. According to some example embodiments of the present disclosure, there is provided a solution for training sample evaluation in positioning. In this solution, a first device receives, from a second device, first information indicating a target accuracy for positioning and a set of parameters for a label quality evaluation of a training sample. The training sample includes a radio measurement and label information associated with the radio measurement. The first device determines a quality parameter of the training sample based on the set of parameters, the label information and the target accuracy. The first device then transmits a report at least comprising the quality parameter to the second device. 30

In this way, the first device can evaluate the label quality of the training sample before transmitting the training sample to the second device. In addition, the first device can report the quality of the training sample to the second device, thus can improve the AI/ML model training performed by the second device.

Example embodiments of the present disclosure will be described in detail below with reference to the accompanying drawings.

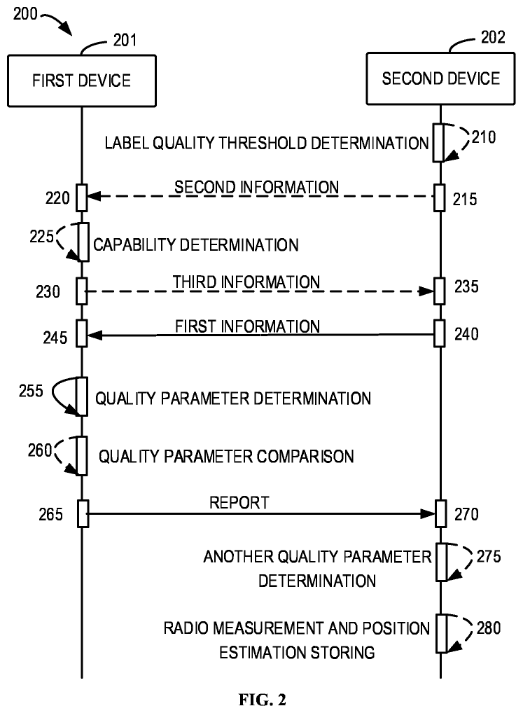

Reference is now made to FIG. 2, which illustrates a signaling chart 200 for communication according to some example embodiments of the present disclosure. As shown in FIG. 2, the signaling chart 200 involves a first device 201 and a second device 202. For the purpose of discussion, reference is made to FIG. 1 to describe the signaling flow 200.

In some example embodiments, the first device 201 may refer to or include the device 110 or device 130 shown in FIG. 1. The second device 202 may refer to or include the device 120 shown in FIG. 1. It is to be understood that the first device 201 and second device 202 may refer to or include any proper devices, including but not limited to a UE, a PRU, a transmit/receive point (TRP), a gNB, a next generation (NG) radio access network (RAN) (NG-RAN) node, or a network element such as LMF. Scope of the present disclosure is not limited in this regard.

Although one first device 201 and one second device 202 are illustrated in FIG. 2, it would be appreciated that there may be a plurality of devices performing similar operations as described with respect to the first device 201 or the second device 202 below.

In some example embodiments, the first device 201 includes the device 110 such as a terminal device. In such cases, the first device 201 may transmit information or signal to the second device 202 via an LTE positioning protocol (LPP) information element (IE), such as an IE in the LPP ProvideLocationInformation. Alternatively, or in addition, in some example embodiments, the first device 201 includes the device 130 such as a network device. In such cases, the first device 201 may transmit information or signal to the second device 202 via an NR positioning protocol annex (NRPPa) IE, such as an IE in NRPPa MeasurementReport. It is to be understood the IEs described hereinafter is only for the purpose of illustration, without suggesting any limitation. The devices may transmit information with any suitable IE or other information format. Scope of the present disclosure is not limited in this regard.

In operation, the second device 202 transmits (240) first information to the first device 201. The first information indicates a target accuracy (TA) for positioning and a set of parameters for a label quality evaluation of a training sample. For example, the first information may be in a LPP IE. The label quality evaluation of training sample represents a process to evaluate the quality of the training sample or the quality of label of the training sample. As used herein, the term “label quality evaluation” may also be referred to as “training sample evaluation”.

In some example embodiments, the TA for positioning may be pre-determined. For example, the TA may be determined based on network requirements.

In some example embodiments, the set of parameters may include a set of coefficients needed to determine the quality parameter. For example, the set of coefficients may include a set of exponential coefficients. Alternatively, or in addition, the set of coefficients may include a set of decay rates. Examples of parameters will be described below.

The training sample includes a radio measurement and label information associated with the radio measurement. The radio measurement and the label information associated with the radio measurement may be obtained by the first device 201 and/or the second device 202. For example, the radio measurement may include positioning measurement such as measurement of field NR signals collected by the first device 201 and/or the second device 202. The positioning measurement may include any combination of time, angle of arrival, channel impulse response (CIR), etc. The positioning measurement may be obtained after receiving a positioning signal. Examples of the positioning signal may include but not limited to a DL positioning reference signal (PRS), a UL sounding reference signal (SRS), or a sidelink (SL) positioning reference signal (SL-PRS).

In some example embodiments, the first device 201 estimates its position using positioning measurements. The estimation results are the position mean μ and variance Σ. If there are several sources of positioning, NR-element calculates and stores a mean and variance for each labeling source.

In some example embodiments, the label information associated with the radio measurement may include any suitable label information, including but not limited to the position estimation of the first device 201 estimated at the time of measurement, a non-line-of-sight (NLOS) indication, time/angular or power measurements, or the like. Scope of the present disclosure is not limited in this regard. 30

In some example embodiments, the label information such as the position estimation may be obtained from at least one positioning source (also referred to as labeling source), including but not limited to global navigation satellite system (GNSS), radio access technology (RAT), LIDAR, Wi-Fi based positioning, ML based positioning, or the like. The training sample with one or several positioning sources of noisy labels may be denoted as the pair (positioning measurement, label 1, label 2, . . . , label M), where label M denotes a 2D or 3D position estimation provided by positioning source M.

In some example embodiments, if the training sample has one labeling source, the training sample evaluation depends on the variance of the position estimation to the TA. In such cases, the first device 201 may perform the label quality evaluation of the training sample based on the TA and a mean and a variance of a position estimation obtained for a positioning source associated with the radio measurement.

In some example embodiments, the training sample has more than one labeling source, the first device 201 may perform the label quality evaluation of the training sample based on the TA and means and variances of position estimations obtained for the positioning sources associated with the radio measurement. Alternatively, or in addition, in some example embodiments, to perform the label quality evaluation, the first device 201 determines (255) a label quality of the training sample. The determination of the label quality will be described below.

As discussed above, the second device transmits (240) the first information to the first device 201. In some example embodiments, the second device 202 may transmit (240) the first information if a training sample evaluation is enabled.

To enable training sample evaluation, the second device 202 may transmit (215) second information to the first device 201. The second information indicates a required type of radio measurement and position estimation. The required type of radio measurement may need to be recorded. The format of reporting estimated position or position estimation may include a mean and variance of estimation. 25

The second information also indicates whether the training sample evaluation is enabled. For example, the second information may include a LPP Provide AssistanceData IE “label consistency score (LCS)=1/0”. This IE is used to enable or disable the training sample evaluation at the first device 201. If LCS is equal to 1, the training sample evaluation is enabled. As discussed above, in some example embodiments, if the training sample evaluation is enabled, the second device 202 transmits (240) the first information to the first device 201. Otherwise, if the LCS is equal to 0, the training sample evaluation is disabled. If the training sample evaluation is disabled, the first device 201 transmits the radio measurements and labels without cleaning or comparing with the TA.

In some example embodiments, the first device 201 receives (220) the second information. The first device 201 may determine (225) whether the first device 201 is capable of providing the required type of radio measurement based on capability information of the first device 201. By way of example, if the required type of radio measurement includes GNSS and LIDAR measurements (that is, the second device 202 asks for GNSS and LIDAR reports), the first device 201 may determine whether the GNSS and LIDAR sources are available. If the GNSS and LIDAR positioning sources become available, the first device 201 is capable of providing the GNSS and LIDAR measurements.

If the first device 201 is capable of providing the required type of radio measurement, the first device 201 transmit (230) third information to the second device 202. The third information indicates that the first device 201 is capable of providing the required type of radio measurement. For example, the third information may include an acknowledgement (ACK), such as a LPP ProvideLocationInformation IE.

In some example embodiments, the second device 202 receives (235) the third information. Based on receiving (235) the third information, the second device 202 transmits (240) the first information. In addition, in some example embodiments, based on receiving (235) the third information, the second device 202 may request a network device serving the device 201 to allocate resources for a following report of positioning measurement.

The first device 201 receives (245) the first information. With the first information, the first device 201 determines (255) a quality parameter of the training sample based on the set of parameters, the label information and the target accuracy. For example, the quality parameter may include a LCS or any the suitable quality parameter. If the positioning measurement(s) or estimation(s) has/have higher accuracy, the LCS value is higher. Otherwise, if the measurement(s) or estimation(s) has/have lower accuracy, the LCS value is lower. In some example embodiments, in case of estimated positions from various sources being consistent, the LCS value will increase proportional to the number of positioning sources.

In some example embodiments, the LCS may be determined by using a suitable LCS metric. Consider M sources of labeling are available for k-dimensional position estimation of a measurement sample. μᵢϵ [symbol] ^{k} and Σᵢϵ [symbol] ^{k×k} are respectively the mean and variance of the estimation reported by the i-th source. The estimated position by the i-th source is Gaussian distributed as Pᵢ˜ [symbol] (μᵢ, Σᵢ). An example LCS metric is as follows:

$$LCS = {max}_{i} {S}_{i} \qquad ( 1 )$$

where Sᵢ denotes the score of i-th source based on two factors: a) its positioning accuracy compared to the TA and b) consistency of the position estimation with other labelling sources.

In some example embodiments, Sᵢ may be defined as follows:

$${S}_{i} = {A}_{i} + {\sum }_{\begin{matrix}j = 1 \\ j \neq i\end{matrix}}^{M} {A}_{i} {A}_{j} {B}_{i , j} \qquad ( 2 )$$

$${A}_{i} = exp ( - {α}_{i} \frac{\sqrt{‖ {\sum }_{i} ‖} - C}{{T}_{A}} ) , {B}_{i , j} = {γ}_{i , j} exp ( - {β}_{i , j} {D}_{KL} ( {P}_{i} \vert \vert {P}_{j} ) ) \qquad ( 3 )$$

where αᵢ>0 is the exponential decay rate for the i-th source. C≥0 is the bias coefficient that controls the range (σᵢ<C) getting Aᵢ≥1. Also, T_{A}>0 is the target accuracy for positioning task. β_{i,j}>0, γ_{i,j}≥0, and D_{KL}(Pᵢ∥Pⱼ)≥0 denote respectively the exponential decay rate, weighting coefficient, and Kullback-Leibler (KL) divergence of two distributions of position by source i and j. For two Gaussian distributions Pᵢ˜ [symbol] (μᵢ, Σᵢ) and Pⱼ˜ [symbol] (μⱼ, Σⱼ), the KL divergence is as follows.

$${D}_{KL} ( {P}_{i} \vert \vert {P}_{j} ) = \frac{1}{2} [ log \frac{‖ {\sum }_{j} ‖}{‖ {\sum }_{i} ‖} + tr \{ {\sum }_{j}^{- 1} {\sum }_{i} \} + {( {μ}_{j} - {μ}_{i} )}^{T} {\sum }_{j}^{- 1} ( {μ}_{j} - {μ}_{i} ) - k ] \qquad ( 4 )$$

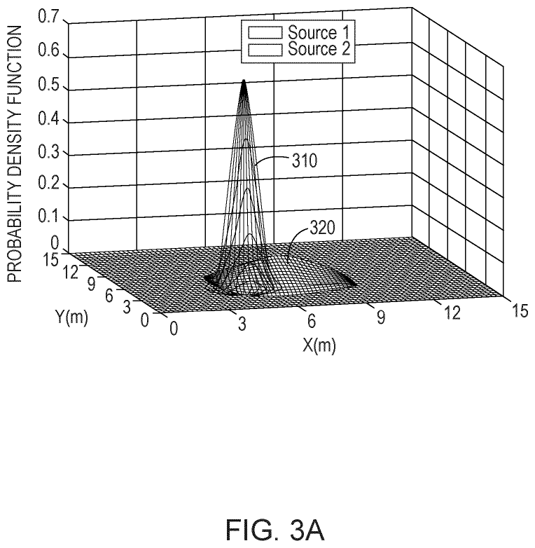

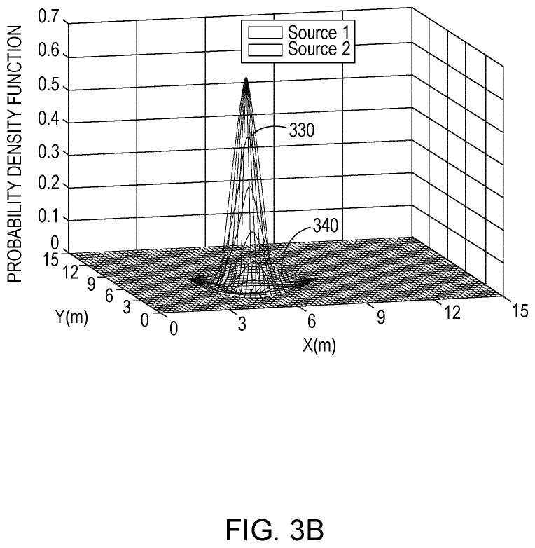

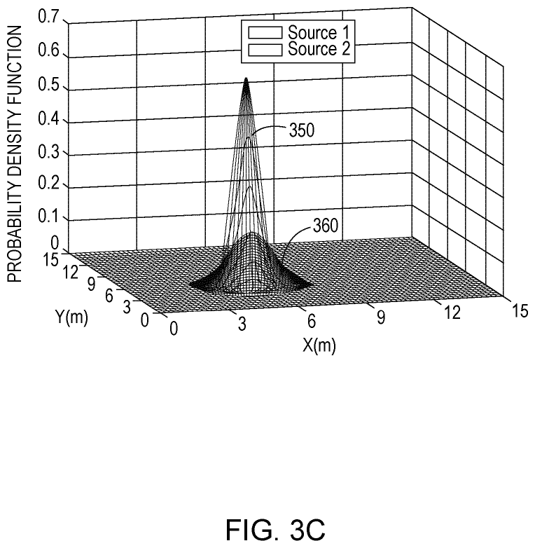

As described above, the set of parameters included in the first information includes a set of coefficients. The set of coefficients may include but not limited to the exponential decay rate αᵢ, the bias coefficient C, the exponential decay rate β_{i,j}, the weighting coefficient γ_{i,j}, or any other suitable parameter. It is to be understood that the example parameters or coefficients are only for the purpose of illustration, without suggesting any limitation. Several example distributions of samples from several positioning sources and the corresponding LCS will be described with respect to FIGS. 3A-3C below.

The first device 201 transmits (265) a report at least include the quality parameter to the second device 202. For example, the first device 201 may transmit (265) the LCS to the second device 202.

In some example embodiments, the report transmitted (265) by the first device 201 may include further information. For example, the report may further include the radio measurement, a position estimation of the first device 201 and the quality parameter.

In some example embodiments, the first device 201 may determine (260) to transmit (265) different reports to the second device 202. The determination (260) may be performed by comparing the quality parameter with a label quality threshold. In some example embodiments, the label quality threshold may be predefined.

Alternatively, or in addition, in some example embodiments, the label quality threshold may be determined (210) by the second device 202. By way of example, the label quality threshold may include a threshold of LCS. The threshold of LCS is also referred to as TH_LCS. In some example embodiments, the second device 202 determines (210) the label quality threshold based on the network requirement or other parameter related to model training. For example, the second device 202 may determine (210) the label quality threshold based on the TA and a size of training dataset for positioning. The label quality threshold may be transmitted to the first device 201 by the second device 202. For example, the label quality threshold may be indicated by the first information transmitted (240) by the second device 202. Alternatively, in some example embodiments, the second device 202 may transmit the label quality threshold separately from the first information.

In some example embodiments, if the first device 201 determines (260) that the quality parameter is smaller than the label quality threshold, the first device 201 transmits (265) the report including the quality parameter to the second device 202. That is, the radio measurement and position estimation may not be transmitted to the second device 202. In this way, the first device 201 can reject or discard the training sample with low LCS. Such training sample evaluation or pre-evaluation helps to be more efficient in data collection and accept/reject a sample based on the label quality or labeling accuracy.

Alternatively, or in addition, in some example embodiments, if the first device 201 determines (260) that the quality parameter is equal to or larger than the label quality threshold, the first device 201 transmits (265), to the second device 202, the report including the quality parameter a position estimation of the first device 201, and the radio measurement. In this way, training samples with one or several sources of noisy labels are pre-evaluated before transmitting to the second device 202. The second device 202 may receive (270) training samples with higher LCS and collect the received (270) training samples as new training data for training the AI/ML model.

In some example embodiments, the first device 201 includes the device 110 such as a terminal device. In such cases, the first device 201 may transmit (265) the report via an IE in the LPP ProvideLocationInformation. Alternatively, or in addition, in some example embodiments, the first device 201 includes the device 130 such as a network device. In such cases, the first device 201 may transmit (265) the report via an IE called “LCS-info” in the NR positioning protocol annex (NRPPa) MeasurementReport.

The second device 202 receives (270) the report from the first device 201.

In some example embodiments, the second device 202 determines whether another positioning source at the second device 202 is available. If the second device 202 determines that the other positioning source is available, the second device 202 determines (275) another label quality parameter based on the position estimation from the first device 201 and another position estimations from the other positioning source at the second device 202. By way of example, the second device 202 calculates LCS by combining the reported position estimation(s) by the first device 201 and possible position estimation(s) from other labeling sources.

Additionally, or alternatively, in some example embodiments, the second device 202 stores (280) the radio measurement and the position estimation with the other quality parameter. Only as an example, the second device 202 adds the radio measurement, estimated position mean(s) and variance(s), and calculated LCS to the training dataset.

In some example embodiments, in case where the second device 202 collects training samples with multiple noisy labels, the second device 202 may choose one among the reported labels or combine those reported labels.

Three example LCSs are calculated to show the evaluation process of training samples with multiple noisy labels for 2D positioning. In the following examples with two noisy positioning sources (M=2), the set of parameters incudes αᵢ=1, β_{i,j}=1, γ_{i,j}=3, ∀i=1, . . . , M j=1, . . . , M. The target accuracy of positioning is set to T_{A}=1. In these examples, the goal is getting position accuracy within the 99% confidence. Thus, as 99% of 2D position Pᵢ˜ [symbol] (μᵢ, Σᵢ) will lie in the range μᵢ±3\sqrt{∥Σᵢ∥}, the coefficient C=T_{A}/3. Such coefficient C leads to get Aᵢ≥1 for sources with 3\sqrt{∥Σᵢ∥}<T_{A}, as labels within the acceptable accuracy range in 99% of the time are provided.

The present disclosure provides a framework for evaluation and cleaning of training samples with different number of labeling sources (which may be collected from different devices). This present framework includes data cleaning, label combination, and cooperation and reporting between the first and second devices. By evaluating the label quality of training sample, the training sample can be cleaned based on the positioning target accuracy and accuracy of the position estimation. Such approach provides an efficient way to compare the usefulness of samples with different number of noisy labels and different estimation accuracies for training the AI/ML model. In addition, by using the signaling chart 200, the transmission overhead can be reduced by pre-evaluation the training sample at the first device and transferring only the samples with enough accuracy to the second device.

Example embodiments according to the present disclosure explores the benefits of augmenting the air interface with features enabling support of AI/ML-based algorithms for enhanced performance and/or reduced complexity/overhead. For example, the present solution can enhance CSI (e.g., overhead reduction, improved accuracy, prediction), beam management (e.g., beam prediction in time, and/or spatial domain for overhead and latency reduction, beam selection accuracy improvement), and positioning accuracy enhancements.

FIG. 3A illustrates example position distributions 310 and 320 for noisy sources of samples from two sources. In the example of FIG. 3A, the two sources provide noisy labels with the following means and variances

$${μ}_{1} = [ \begin{matrix}5 \\ 5\end{matrix} ] , {\sum }_{1} = [ \begin{matrix}1 / 4 & 0 \\ 0 & 1 / 4\end{matrix} ] ; {μ}_{1} = [ \begin{matrix}7 \\ 7\end{matrix} ] , {\sum }_{2} = [ \begin{matrix}9 / 4 & 0 \\ 0 & 9 / 4\end{matrix} ] .$$

Table 1 below shows the calculated parameters using (1)-(4) described above. In this example, the

$$LCS = {max}_{i} {S}_{i} = 0.955 .$$

The calculated LCS is higher than A₁ which is equal to 0.847 because of the overlap of the position distributions from the two noisy sources.

TABLE 1
calculated LCS parameters

| A | D_{K}L | B | S |
|---|---|---|---|
| $[ \begin{matrix}{A}_{1} = 0.847 \\ {A}_{2} = 0.311\end{matrix} ]$ | $[ \begin{matrix}{D}_{KL} ( {P}_{1} ‖ {P}_{1} ) = 0 & {D}_{KL} ( {P}_{1} ‖ {P}_{2} ) = 1.99 \\ {D}_{KL} ( {P}_{2} ‖ {P}_{1} ) = 22.9 & {D}_{KL} ( {P}_{2} ‖ {P}_{2} ) = 0\end{matrix} ]$ | $[ \begin{matrix}- & {B}_{1 , 2} = 0.41 \\ {B}_{2 , 1} = 0. & -\end{matrix} ]$ | $[ \begin{matrix}{S}_{1} = 0.955 \\ {S}_{2} = 0.311\end{matrix} ]$ |

FIG. 3B illustrates further example position distributions 330 and 340 for noisy sources of samples from two sources. In this example, the mean of second source is moved to be closer in the first source mean, i.e.,

$${μ}_{1} = [ \begin{matrix}5 \\ 5\end{matrix} ] , {\sum }_{1} = [ \begin{matrix}1 / 4 & 0 \\ 0 & 1 / 4\end{matrix} ] ; {μ}_{1} = [ \begin{matrix}5.5 \\ 5.5\end{matrix} ] , {\sum }_{2} = [ \begin{matrix}9 / 4 & 0 \\ 0 & 9 / 4\end{matrix} ] .$$

The calculated parameters for obtaining LCS is listed in Table 2. As the reported positions by different sources support more each other, LCS is increased to

$$LCS = {max}_{i} {S}_{i} = 1.420 .$$

TABLE 2
calculated LCS parameters

| A | D_{KL} | B | S |
|---|---|---|---|
| $[ \begin{matrix}{A}_{1} = 0.847 \\ {A}_{2} = 0.311\end{matrix} ]$ | $[ \begin{matrix}{D}_{KL} ( {P}_{1} ‖ {P}_{1} ) = 0 & {D}_{KL} ( {P}_{1} ‖ {P}_{2} ) = 0.32 \\ {D}_{KL} ( {P}_{2} ‖ {P}_{1} ) = 7.9 & {D}_{KL} ( {P}_{2} ‖ {P}_{2} ) = 0\end{matrix} ]$ | $[ \begin{matrix}- & {B}_{1 , 2} = 2.18 \\ {B}_{2 , 1} = 0.001 & -\end{matrix} ]$ | $[ \begin{matrix}{S}_{1} = 1.42 \\ {S}_{2} = 0.312\end{matrix} ]$ |

FIG. 3C illustrates still further example position distributions 350 and 360 for noisy sources of samples from two sources. In the example of FIG. 3C, the two sources provide noisy labels with the following means and variances

$${μ}_{1} = [ \begin{matrix}5 \\ 5\end{matrix} ] , {\sum }_{1} = [ \begin{matrix}1 / 4 & 0 \\ 0 & 1 / 4\end{matrix} ] ; {μ}_{1} = [ \begin{matrix}5.5 \\ 5.5\end{matrix} ] , {\sum }_{2} = [ \begin{matrix}1 & 0 \\ 0 & 1\end{matrix} ] .$$

Table 3 below shows the calculated parameters using (1)-(4) described above. In this example, the LCS=ᵢmax Sᵢ=1.921. As it is shown in Table 3 and FIG. 3C, A₂ is increased and the KL divergence between the distributions is decreased. Thus, the LCS achieves higher score. That is, having two highly overlapped and confidence labelling sources by reducing the variance of the second source will lead to a higher LCS.

TABLE 3
calculated LCS parameters

| A | D_{KL} | B | S |
|---|---|---|---|
| $[ \begin{matrix}{A}_{1} = 0.847 \\ {A}_{2} = 0.513\end{matrix} ]$ | $[ \begin{matrix}{D}_{KL} ( {P}_{1} ‖ {P}_{1} ) = 0 & {D}_{KL} ( {P}_{1} ‖ {P}_{2} ) = 0.19 \\ {D}_{KL} ( {P}_{2} ‖ {P}_{1} ) = 3.31 & {D}_{KL} ( {P}_{2} ‖ {P}_{2} ) = 0\end{matrix} ]$ | $[ \begin{matrix}- & {B}_{1 , 2} = 2.47 \\ {B}_{2 , 1} = 0.11 & -\end{matrix} ]$ | $[ \begin{matrix}{S}_{1} = 1.921 \\ {S}_{2} = 0.561\end{matrix} ]$ |

By using the example embodiments, the training samples from those example noisy sources can be evaluated before transmission to the second device 202. In this way, the training samples used in the AI/ML model training can be cleaned. It will enhance the training of the AI/ML model, and thus improve the positioning accuracy. In addition, such sample reporting will also reduce the overhead.

### Example Methods

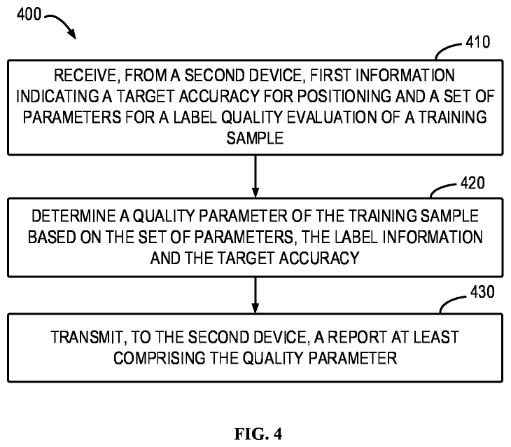

FIG. 4 illustrates a flowchart of a method 400 implemented at a first device according to some example embodiments of the present disclosure. For example, the first device may include a terminal device or a network device. For the purpose of discussion, the method 400 will be described from the perspective of the first device 201 in FIG. 2.

At block 410, the first device 201 receives, from the second device 202, first information indicating a target accuracy for positioning and a set of parameters for a label quality evaluation of a training sample. The training sample includes a radio measurement and label information associated with the radio measurement.

In some example embodiments, the first device 201 may include a terminal device and the second device 202 may include a core network deice. Alternatively, in some example embodiments, the first device 201 may include a network device and the second device 202 may include the core network device.

In some example embodiments, the set of parameters includes a set of coefficients that are needed to determine the quality parameter. For example, the set of coefficients may include at least one of: a set of exponential coefficients or a set of decay rates.

In some example embodiments, the radio measurement and the label information associated with the radio measurement is obtained from at least one of: the first device 201 or the second device 202.

At block 420, the first device 201 determines a quality parameter of the training sample based on the set of parameters, the label information, and the target accuracy.

At block 430, the first device 201 transmits, to the second device 202, a report at least comprising the quality parameter.

In some example embodiments, the information further indicates a label quality threshold. The first device 201 may determine whether the quality parameter is smaller than the label quality threshold. Based on determining that the quality parameter is not smaller than the label quality threshold, at block 430, the first device 201 transmits to the second device 202, the report comprising the quality parameter, a position estimation of the first device, and the radio measurement. Alternatively, or in addition, in some example embodiments, based on determining that the quality parameter is smaller than the label quality threshold, at block 430, the first device 201 transmits, to the second device 202, the report comprising the quality parameter.

In some example embodiments, the first device 201 may perform the label quality evaluation of the training sample based on the target accuracy and a mean and a variance of a position estimation obtained for a positioning source associated with the radio measurement.

In some example embodiments, the first device 201 may receive, from the second device 202, second information indicating a required type of radio measurement and position estimation and an indication regarding whether the label quality evaluation is enabled. The first device 201 may determine whether the first device 201 is capable of providing the required type of radio measurement based on capability information of the first device. Based on determining that the first device 201 is capable of providing the required type of radio measurement, the first device 201 transmits, to the second device 202, third information indicating that the first device 201 is capable of providing the required type of radio measurement.

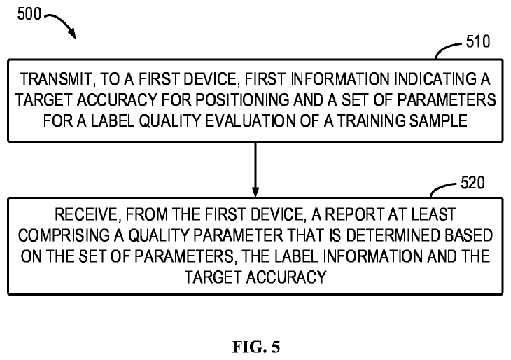

FIG. 5 illustrates a flowchart of a method 500 implemented at a second device according to some example embodiments of the present disclosure. For example, the second device may include a core network device. For the purpose of discussion, the method 400 will be described from the perspective of the second device 202 in FIG. 2.

At block 510, the second device 202 transmits, to the first device 201, first information indicating a target accuracy for positioning and a set of parameters for a label quality evaluation of a training sample. The training sample comprises a radio measurement and label information associated with the radio measurement.

In some example embodiments, the first device 201 may include a terminal device and the second device 202 may include a core network deice. Alternatively, in some example embodiments, the first device 201 may include a network device and the second device 202 may include the core network device.

In some example embodiments, the set of parameters may include a set of coefficients that are needed to calculate the quality parameter. For example, the set of coefficients may include at least one of: a set of exponential coefficients or a set of decay rates.

In some example embodiments, the radio measurement and the label information associated with the radio measurement is obtained from at least one of: the first device 201 or the second device 202.

At block 520, the second device 202 receives, from the first device 201, a report at least comprising a quality parameter that is determined based on the set of parameters, the label information, and the target accuracy.

In some example embodiments, the information further indicates a label quality threshold. If the quality parameter is not smaller than the label quality threshold, at block 520, the second device 202 receives, from the first device 201, the report comprising the quality parameter, a position estimation of the first device 201 and the radio measurement. Alternatively, or in addition, in some example embodiments, if the quality parameter is smaller than the label quality threshold, at block 520, the second device 202 receives, from the first device 201, the report comprising the quality parameter.

In some example embodiments, the second device 202 may determine the label quality threshold based on the target accuracy and a size of a training dataset for positioning.

In some example embodiments, the second device 202 may transmit, to the first device 201, second information indicating a required type of radio measurement and position estimation and an indication regarding whether the label quality evaluation is enabled. The second device 202 may receive, from the first device 201, third information indicating that the first device 201 is capable of providing the required type of radio measurement.

In some example embodiments, the second device 202 may determine whether another positioning source at the second device 202 is available. Based on determining that the other positioning source at the second device 202 is available, the second device 202 determines another label quality parameter based on the position estimation from the first device 201 and another position estimations from the other positioning source at the second device 202.

In some example embodiments, the second device 202 may store the radio measurement and the position estimation with the other quality parameter.

### Example Apparatus, Device and Medium

In some example embodiments, a first apparatus capable of performing any of the method 400 (for example, the device 201 in FIG. 2) may comprise means for performing the respective operations of the method 400. The means may be implemented in any suitable form. For example, the means may be implemented in a circuitry or software module. The first apparatus may be implemented as or included in the first device 201 in FIG. 2.

In some example embodiments, the first apparatus comprises means for receiving, from a second apparatus, first information indicating a target accuracy for positioning and a set of parameters for a label quality evaluation of a training sample. The training sample comprises a radio measurement and label information associated with the radio measurement. The first apparatus further comprises mean for determining a quality parameter of the training sample based on the set of parameters, the label information, and the target accuracy; and means for transmitting, to the second apparatus, a report at least comprising the quality parameter.

In some example embodiments, the first apparatus may include a terminal device and the second apparatus may include a core network deice. Alternatively, in some example embodiments, the first apparatus may include a network device and the second apparatus may include the core network device.

In some example embodiments, the radio measurement and the label information associated with the radio measurement is obtained from at least one of: the first apparatus or the second apparatus.

In some example embodiments, the set of parameters comprises a set of coefficients that are needed to determine the quality parameter. For example, the set of coefficients comprises at least one of: a set of exponential coefficients or a set of decay rates.

In some example embodiments, the information further indicates a label quality threshold. The means for transmitting the report comprises: means for determining whether the quality parameter is smaller than the label quality threshold; and means for based on determining that the quality parameter is not smaller than the label quality threshold, transmitting, to the second apparatus, the report comprising the quality parameter, a position estimation of the first apparatus, and the radio measurement.

In some example embodiments, the information further indicates a label quality threshold. The means for transmitting the report comprises: means for determining whether the quality parameter is smaller than the label quality threshold; and means for based on determining that the quality parameter is smaller than the label quality threshold, transmitting, to the second apparatus, the report comprising the quality parameter.

In some example embodiments, the first apparatus further comprises: means for performing the label quality evaluation of the training sample based on the target accuracy and a mean and a variance of a position estimation obtained for a positioning source associated with the radio measurement.

In some example embodiments, the first apparatus further comprises: means for receiving, from the second apparatus, second information indicating a required type of radio measurement and position estimation and an indication regarding whether the label quality evaluation is enabled; means for determining whether the first apparatus is capable of providing the required type of radio measurement based on capability information of the first apparatus; and means for based on determining that the first apparatus is capable of providing the required type of radio measurement, transmitting, to the second apparatus, third information indicating that the first apparatus is capable of providing the required type of radio measurement.

In some example embodiments, the first apparatus further comprises means for performing other operations in some example embodiments of the method 400 or the first device 201. In some example embodiments, the means comprises at least one processor; and at least one memory storing instructions that, when executed by the at least one processor, cause the performance of the first apparatus.

In some example embodiments, a second apparatus capable of performing any of the method 500 (for example, the second device 202 in FIG. 2) may comprise means for performing the respective operations of the method 500. The means may be implemented in any suitable form. For example, the means may be implemented in a circuitry or software module. The second apparatus may be implemented as or included in the second device 202 in FIG. 2.

In some example embodiments, the second apparatus comprises means for transmitting, to a first apparatus, first information indicating a target accuracy for positioning and a set of parameters for a label quality evaluation of a training sample. The training sample comprises a radio measurement and label information associated with the radio measurement. The second apparatus further comprises means for receiving, from the first apparatus, a report at least comprising a quality parameter that is determined based on the set of parameters, the label information, and the target accuracy.

In some example embodiments, the first apparatus may include a terminal device and the second apparatus may include a core network deice. Alternatively, in some example embodiments, the first apparatus may include a network device and the second apparatus may include the core network device.

In some example embodiments, the set of parameters comprises a set of coefficients that are needed to calculate the quality parameter. For example, the set of coefficients comprises at least one of: a set of exponential coefficients or a set of decay rates.

In some example embodiments, the radio measurement and the label information associated with the radio measurement is obtained from at least one of: the first apparatus or the second apparatus.

In some example embodiments, the information further indicates a label quality threshold. The means for receiving the report comprises means for in accordance with a determination that the quality parameter is not smaller than the label quality threshold, receiving, from the first apparatus, the report comprising the quality parameter, a position estimation of the first apparatus and the radio measurement. Alternatively, or in addition, in some example embodiments, the means for receiving the report comprises: means for in accordance with a determination that the quality parameter is smaller than the label quality threshold, receiving, from the first apparatus, the report comprising the quality parameter.

In some example embodiments, the second apparatus further comprises: means for determining the label quality threshold based on the target accuracy and a size of a training dataset for positioning.

In some example embodiments, the second apparatus further comprises: means for transmitting, to the first apparatus, second information indicating a required type of radio measurement and position estimation and an indication regarding whether the label quality evaluation is enabled; and means for receiving, from the first apparatus, third information indicating that the first apparatus is capable of providing the required type of radio measurement.

In some example embodiments, the second apparatus further comprises: means for determining whether another positioning source at the second apparatus is available; and means for based on determining that the other positioning source at the second apparatus is available, determining another label quality parameter based on the position estimation from the first apparatus and another position estimations from the other positioning source at the second apparatus.

In some example embodiments, the second apparatus further comprises: means for storing the radio measurement and the position estimation with the other quality parameter.

In some example embodiments, the second apparatus further comprises means for performing other operations in some example embodiments of the method 500 or the second device 202. In some example embodiments, the means comprises at least one processor; and at least one memory storing instructions that, when executed by the at least one processor, cause the performance of the second apparatus.

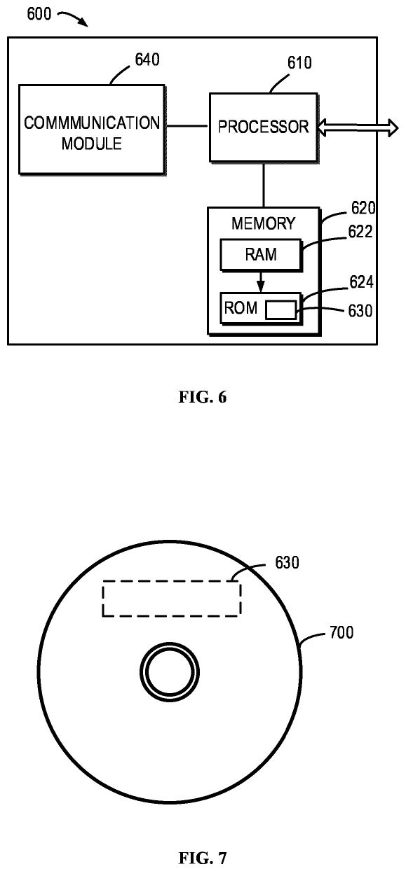

FIG. 6 is a simplified block diagram of a device 600 that is suitable for implementing example embodiments of the present disclosure. The device 600 may be provided to implement a communication device, for example, the first device 201 or the second device 202 as shown in FIG. 2. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The instructions of the program 630 may include instructions for performing operations/acts of some example embodiments of the present disclosure. The program 630 may be stored in the memory, e.g., the ROM 624. The processor 610 may perform any suitable actions and processing by loading the program 630 into the RAM 622.

The example embodiments of the present disclosure may be implemented by means of the program 630 so that the device 600 may perform any process of the disclosure as discussed with reference to FIG. 2, FIG. 4 and FIG. 5. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 7 shows an example of the computer readable medium 700 which may be in form of CD, DVD or other optical storage disk. The computer readable medium 700 has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous.

Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

A list of Abbreviations

| | |
|---|---|
| LMF | Location Management Function |
| PRS | Positioning Reference Signal |
| SRS | Sounding Reference Signal |
| PRU | Positioning Reference Unit |
| TRP | Transmit Receive Point |
| GNSS | Global Navigation Satellite System |
| IE | Information Element |
| NR | New Radio |
| NRPPa | NR Positioning Protocol Annex |
| TA | Target Accuracy |
| LCS | label consistency score |
| CIR | Channel Impulse Response |
| 2D | Two Dimensional |
| 3D | Three Dimensional |
| RAT | Radio Access Technology |
| UE | User Equipment |
| 5G | Fifth Generation |
| LTE | Long Term Evolution |
| LTE-A | LTE-Advanced |
| LPP | LTE Positioning Protocol |
| WCDMA | Wideband Code Division Multiple Access |
| BS | Base Station |
| AP | Access Point |
| eNodeB | Evolved NodeB |
| gNB/NR NB | Next Generation NodeB |
| Tx | Transmitting |
| Rx | Receiving |
| DL | Downlink |
| UL | Uplink |
| SL | Sidelink |
| SL-PRS | Sidelink Positioning Reference Signal |
| AI | Artificial Intelligence |
| ML | Machine Learning |
| NWDAF | Network Data Analytics Function |
| NLOS | Non-Line-of-Sight |
| RAN | Radio Access Network |
| NG-RAN | Next Generation Radio Access Network |

1-43. (canceled)

44. A first device comprising:
at least one processor; and
at least one memory storing instructions that, when executed by the at least one processor, cause the first device at least to perform:
receiving, from a second device, first information indicating a target accuracy for positioning and a set of parameters for a label quality evaluation of a training sample, the training sample comprising a radio measurement and label information associated with the radio measurement;
determining a quality parameter of the training sample based on the set of parameters, the label information, and the target accuracy; and
transmitting, to the second device, a report at least comprising the quality parameter.

45. The first device of claim 44, wherein the set of parameters comprises a set of coefficients that are needed to determine the quality parameter.

46. The first device of claim 45, wherein the set of coefficients comprises at least one of: a set of exponential coefficients or a set of decay rates.

47. The first device of claim 44, wherein the information further indicates a label quality threshold, and
wherein transmitting the report comprises:
determining whether the quality parameter is smaller than the label quality threshold; and
based on determining that the quality parameter is not smaller than the label quality threshold, transmitting, to the second device, the report comprising the quality parameter, a position estimation of the first device, and the radio measurement.

48. The first device of claim 44, wherein the information further indicates a label quality threshold, and
wherein transmitting the report comprises:
determining whether the quality parameter is smaller than the label quality threshold; and
based on determining that the quality parameter is smaller than the label quality threshold, transmitting, to the second device, the report comprising the quality parameter.

49. The first device of claim 44, wherein the first device is caused to perform:
performing the label quality evaluation of the training sample based on the target accuracy and a mean and a variance of a position estimation obtained for a positioning source associated with the radio measurement.

50. The first device of claim 44, wherein the first device is caused to perform:
receiving, from the second device, second information indicating a required type of radio measurement and position estimation and an indication regarding whether the label quality evaluation is enabled;
determining whether the first device is capable of providing the required type of radio measurement based on capability information of the first device; and
based on determining that the first device is capable of providing the required type of radio measurement, transmitting, to the second device, third information indicating that the first device is capable of providing the required type of radio measurement.

51. The first device of claim 44, wherein the radio measurement and the label information associated with the radio measurement is obtained from at least one of: the first device or the second device.

52. The first device of claim 44, wherein the first device comprises a terminal device and the second device comprises a core network device, or
wherein the first device comprises a network device and the second device comprises the core network device.

53. A second device comprising:
at least one processor; and
at least one memory storing instructions that, when executed by the at least one processor, cause the second device at least to perform:
transmitting, to a first device, first information indicating a target accuracy for positioning and a set of parameters for a label quality evaluation of a training sample, the training sample comprising a radio measurement and label information associated with the radio measurement; and
receiving, from the first device, a report at least comprising a quality parameter that is determined based on the set of parameters, the label information, and the target accuracy.

54. The second device of claim 53, wherein the set of parameters comprises a set of coefficients that are needed to calculate the quality parameter.

55. The second device of claim 54, wherein the set of coefficients comprises at least one of: a set of exponential coefficients or a set of decay rates.

56. The second device of claim 53, wherein the information further indicates a label quality threshold, and
wherein receiving the report comprises:
in accordance with a determination that the quality parameter is not smaller than the label quality threshold, receiving, from the first device, the report comprising the quality parameter, a position estimation of the first device and the radio measurement.

57. The second device of claim 53, wherein the information further indicates a label quality threshold, and
wherein receiving the report comprises:
in accordance with a determination that the quality parameter is smaller than the label quality threshold, receiving, from the first device, the report comprising the quality parameter.

58. The second device of claim 53, wherein the second device is caused to perform:
determining the label quality threshold based on the target accuracy and a size of a training dataset for positioning.

59. The second device of claim 53, wherein the second device is caused to perform:
transmitting, to the first device, second information indicating a required type of radio measurement and position estimation and an indication regarding whether the label quality evaluation is enabled; and
receiving, from the first device, third information indicating that the first device is capable of providing the required type of radio measurement.

60. The second device of claim 53, wherein the second device is caused to perform:
determining whether another positioning source at the second device is available; and
based on determining that the other positioning source at the second device is available, determining another label quality parameter based on the position estimation from the first device and another position estimations from the other positioning source at the second device.

61. The second device of claim 60, wherein the second device is caused to perform:
storing the radio measurement and the position estimation with the other quality parameter.

62. The second device of claim 53, wherein the radio measurement and the label information associated with the radio measurement is obtained from at least one of: the first device or the second device.

63. The second device of claim 53, wherein the first device comprises a terminal device and the second device comprises a core network device, or
wherein the first device comprises a network device and the second device comprises the core network device.
